(19) United States
(12) Patent Application Publication
(10) Pub. No.: US 2016/0212475 A1
(43) Pub. Date: Jul. 21, 2016

(54) DYNAMICALLY GENERATED USER INTERFACE

(71) Applicant: EchoStar Technologies L.L.C., Englewood, CO (US)

(72) Inventors: Karen Taxier, Highlands Ranch, CO (US); Kristen Swanson, Denver, CO (US)

(73) Assignee: EchoStar Technologies L.L.C.

(21) Appl. No.: 14/598,395

(22) Filed: Jan. 16, 2015

(51) Int. Cl. H04N 21/431; H04N 21/44; H04N 21/485; H04N 21/439

(52) U.S. Cl. CPC H04N 21/4312; H04N 21/4394; H04N 21/44008; H04N 21/4854

(57) ABSTRACT

Data is received specifying display elements for a graphical user interface. The data includes at least a first display element provided for user interaction with the graphical user interface. The data further includes a second display element associated with a description of an item of media content. A display characteristic of at least one of the first and second display elements is adjusted based on a rule specifying one of a complementary and a contrasting display of the first and second display elements.

### BACKGROUND

Media devices such as set-top boxes are used in customer premises to receive media content, e.g., television programming, movies, sporting events, etc. Further, a set-top box or the like may provide a graphical user interface (GUI) or the like that includes an interactive program guide (IPG). The IPG generally includes elements such as icons and/or written descriptions representing and/or describing available programming, channels, etc. A display such as a television connected to a set-top box may be used to present a GUI, including an IPG. However, the IPG provided in such a display may sometimes be difficult to view. For example, media content represented in the IPG may be presented according to images and/or text, including fonts, colors, etc., particular to an item of media content. Further, the IPG may provide menu items or the like in specified colors, fonts, etc. Unfortunately, at present, IPG items such as menu items, descriptions, widgets, etc., may be difficult to view because colors, shadings, etc. present in sufficient contrast with colors, fonts, shadings, etc. of a media content description displayed in the IPG.

### SUMMARY OF THE DRAWINGS

FIG. 1 is a block diagram of an exemplary media content delivery system.

FIG. 2 is a block diagrams of an exemplary interactive program guide user interface.

FIG. 3 is a diagram of an exemplary process for dynamically generating a graphical user interface such as an interactive program guide.

### DETAILED DESCRIPTION

### Overview

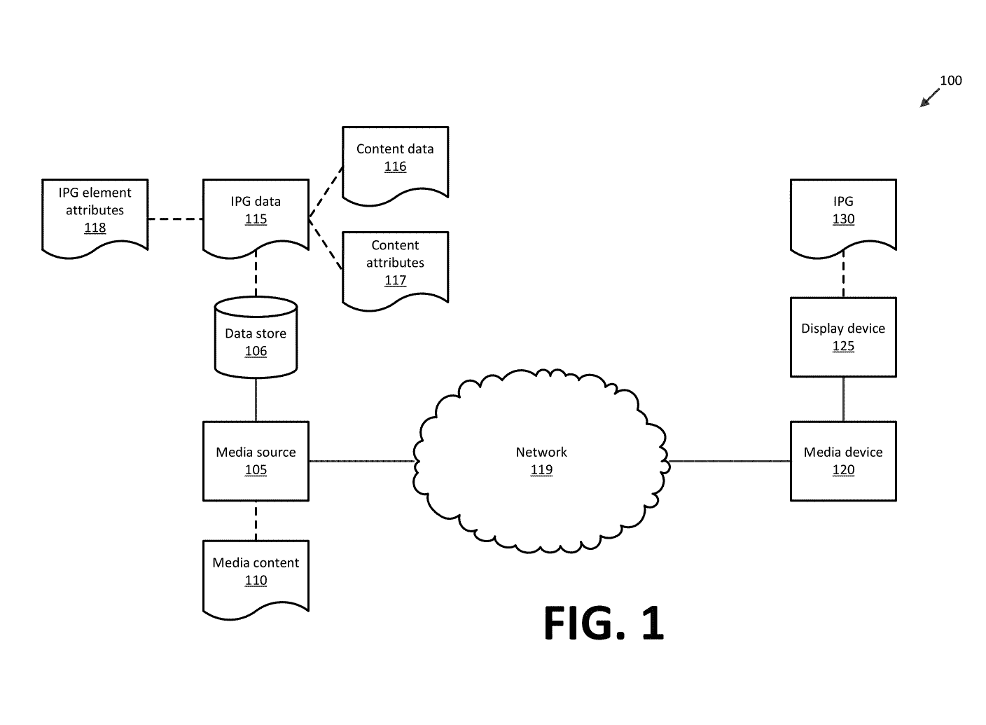

FIG. 1 is a block diagram of an exemplary media content delivery system 100. Using certain elements of the system 100 as disclosed herein, in an exemplary implementation, a media source 105 may provide media content, e.g., audio and/or video. The content 110 may be provided via a network 119 to a media device 120. Further, the content 110 may be displayed to a user via the media device 120 and/or a media display device 125 such as a television, video monitor, or the like. The media device 120 may also receive data to be used in displaying a graphical user interface (GUI), e.g., interactive program guide (IPG) data 115 from a data store 106 associated with the media source 105. The media device 120 is generally programmed to use the data 115 to provide an IPG 130 via the display device 125.

Further, the media device 120 is programmed to dynamically generate and/or adjust the IPG 130. For example, IPG data 115 provided to the media device 120 can include content data 116, e.g., images, text, etc., describing an item of media content 110, as well as content attributes 117, e.g., information concerning display characteristics such as colors, fonts, shadings, etc. in the content data 116. The IPG data 115 can further include IPG element attributes 118 indicating such display characteristics of a elements, e.g., menu items or the like, of a GUI such as the IPG 130. The data 115 can then be provided to the media device 120 from the data store 106 and/or generated in the media device 120 or some other device. The media device 120 can, based on a comparison of the content display attributes 117 and the IPG element attributes 118, determine characteristics for dynamically generating the IPG 130 displaying a particular set of IPG data 115. For example, the media device 120 can dynamically determine colors, fonts, locations, etc. of various elements of an IPG 130, thereby reducing a user's potential difficulties in viewing the IPG 130, better drawing a user's attention to a description of the media content 110, etc., i.e., generally provide a better user experience.

### Exemplary System Elements

A media content source 105 may be any one, or some combination, of various mechanisms for providing the IPG data 115, and generally also for delivering media content 110. The specific configuration of a media content source 105 may depend on a type of media content 110 being provided. By way of example and not limitation, media content 110 data may be provided as video-on-demand through a cable, satellite or internet protocol television (IPTV) distribution system, as streaming Internet video data (e.g., from a site such as Netflix, YouTube, Hulu, etc.), or as some other kind of data. Further for example, the media content source 105 could be a computer readable medium included in or accessible by the media device 120, e.g., an optical disc such as a DVD (sometimes referred to as a digital video disk) or Blu-ray™ disc, etc. In general, examples of media content 110 include various types of data, including audio, video, images, etc. Accordingly, examples of content sources 105 may include one or more of a cable or satellite television head end, a video streaming service such as generally includes a multimedia web server (or some other computing device), or some other mechanism for delivering multimedia data.

Further, the media source 105 generally includes an/or is communicatively coupled to a data store 106. As stated above, the data store 106 may include IPG data 115 as well as display parameters 118. The data store 106 may include known hardware and/or software for storing the data 115, including content data 116, content attributes 118, IPG element attributes 118, etc.

Media content 110 is generally delivered via the network 119 in a digital format, e.g., as compressed audio and/or video data. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 110 may be provided in a format such as the MPEG-2 or the H.264/MPEG-4 Advanced Video Coding standards (AVC) (H.264 and MPEG-4 at present being consistent), or according to some other standard or standards. For example, media content 110 could be audio data formatted according to standards such as MPEG-1 or MPEG-2 Audio Layer III (MP3), Advanced Audio Coding (AAC), etc. Further, the foregoing standards generally include support for metadata. Content 110 using a standard or standards that do not explicitly include provisions for metadata, or standards that have limitations on metadata size, may be supplemented with discrete metadata (e.g. separate files) which uses either embedded metadata or information such as timecodes/time stamps/timing intervals which can be used to modify the standard content 110. Content 110 metadata generally includes indexes, pointers, or other mechanisms for identifying locations in media content 110.

IPG data 115, as mentioned above, generally includes content data 116 as well as content attribute data 117. However, alternatively or additionally, as discussed further below, content attribute data 117 could be generated by a media device 120 or some other device, rather than being provided by the media source 105.

Content data 116 generally specifies one or more display elements for a GUI such as the IPG 130, a display element being an element that is displayed in the IPG 130, such as a button, link, menu item, background, image, textual display, etc. Accordingly, the content data 116 may comprise multimedia data including one or more of text, images, audio, video, etc., relating to an item of media content 110. For example, content data 116 may describe an item of media content 110 such as a movie, and thus may include a textual description of the movie, audio and/or video extracted from the movie, still images or illustrations of the movie, etc.

Content attribute data 117 may describe attributes, sometimes referred to as display characteristics, of the content data 116, e.g., of particular display elements. For example, the content attribute data 117 may describe a font or color of text included in the content data 116. Likewise, the content attribute data 117 may describe a color, shading, etc. of other elements of the content data 116, e.g., a color of a background or the like.

Content attribute data 117 may be generated in a variety of ways. For example, an operator could specify various display characteristics of an item of content data 116 to be included in the content data 117 for the item of content data 116. Additionally or alternatively, an automated process, such as is known, could be used to analyze content data 116. For example, as is known, a video or image file can be analyzed to identify attributes of pixels, e.g., brightness (i.e., pixel intensity, as is known), shading or transparency, color, etc. Likewise, an audio file included in content data 116 can be analyzed for tone, loudness, etc. Yet further, images including text can be analyzed to determine text size, font, colors of characters, attributes of characters such as italics, shadow, etc.

IPG element attributes 118, similar to content attribute data 117, indicate display characteristic of IPG elements such as menu items, links, etc.

The network 119 represents one or more mechanisms for delivering content 110 from a content source 105 to a media device 120. Accordingly, the network 119 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, providing data communication services.

The media device 120 is generally a device including a computer processor and associated storage, e.g., volatile memory and/or nonvolatile memory, etc., and capable of communicating via the network 119 and playing content 110. Exemplary media devices 120 include a set-top box, a personal computer such as a laptop, handheld, or tablet computer, a smart phone, etc. Further, the media device 120 may be connected to a separate display device 125, e.g., a monitor or television, or may incorporate a display device 125, e.g., a display of a tablet or personal computer media device 120. When content 110 is referred to herein as being “displayed” it is to be understood that such display could include any possible mode of displaying media data, such as a display of visual data, audio data, etc. For example, content 110 could be displayed by showing video or image data on a screen with or without sound, by playing audio data with or without a visual display, etc.

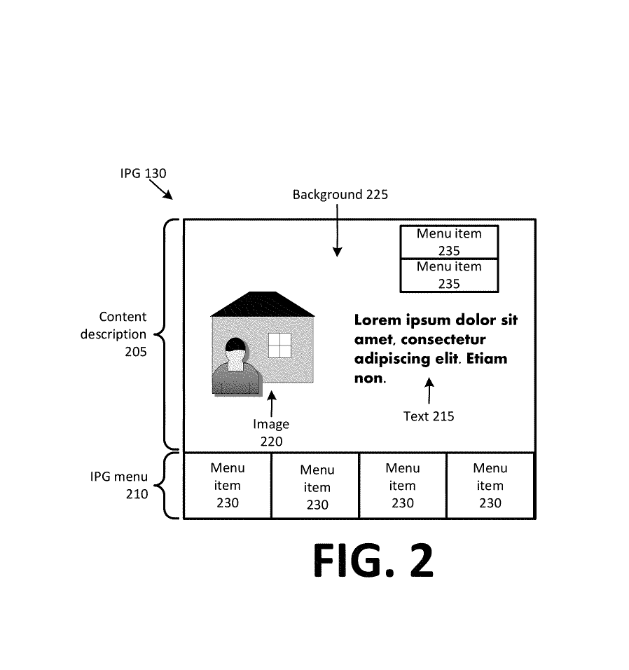

The IPG 130, as stated above, may be a known interactive program guide or the like provided by a media content 110 provider, e.g., listing channels, programs, items of media content 110, etc. available for consumption. FIG. 2 is a block diagrams of an exemplary IPG 130, including various display elements as explained further below. Note that the IPG 130 is discussed herein as an example of a GUI, and that principles, elements, and/or steps described herein with respect to the IPG 130 could be applied to other GUIs.

In the example of FIG. 2, the IPG 130 includes two sets of display elements, i.e., a content description 205 and user interaction elements 210. Each of the content description 205 and the interaction elements 210 may be rendered by the media device 120 according to the IPG data 115. The content description 205 may be included in the content data 116 of the IPG data 115. For example, the content description 205 may include display elements such as text 215, an image 220, and a background 225. Although not shown in FIG. 2, other display elements of the content description 205 could include a link to, or an embedded, audio file , video file, etc. The user interaction elements 210 are generally mechanisms for user interaction with the IPG 130, e.g., for receiving user input and/or for providing information to a user concerning display of media content 110, operation of the device 120, etc. Further, although display elements such as IPG menu items 230 are generally included in the interactive elements 210, menu items 235 could be displayed within the content description 205, e.g., as illustrated in FIG. 2.

As mentioned above, various elements of the content description 205 include characteristics that may be indicated in the content attribute data 115, for example, shading or coloring of the image 220, a size, coloring, etc. of the text 215, a color brightness, and/or shading of the background 225, etc. Further, the IPG data 115 may specify default colors for menu items 230, 235. For example, a menu item 230 could have a background of the first color and include text, e.g., “Purchase,” “View,” “Show Cast,” “See Similar,” etc., the text having a second color.

The media device 120 is generally programmed to compare display characteristics, e.g., generally obtained from content attributes 117, of respect sets of display elements, and to adjust one or both of the sets of display elements to improve and/or enhance a user experience, e.g., to make a GUI such as the IPG 130 more compelling and/or easier for a user to view.”. For example, the device 120 may be programmed to compare display characteristics of the content description 205 with display characteristics of the IPG menu 210 menu items 230 as well as possibly menu items 235, e.g. generally obtained from the IPG element attributes 118. The media device 120 is further generally programmed to dynamically generate a GUI, e.g., the IPG 130, according to the comparison. For example, the content description 205 and/or the IPG menu 210 items 230 and/or menu items 235 could be generated to optimize a viewing experience. That is, the device 120 could compare colors, brightnesses, etc., of menu items 230, 235 with elements in the content description 205. The device 120 could then be programmed to apply a rule specifying generation of complementary display characteristics for various display elements, e.g., to generate the IPG 130 so that display characteristics of various display elements of the IPG 130 complement each other. For example, the device 120 could be programmed to make a font and/or font color of menu items 230 match a font and/or font color of text 215. Further for example, a background color of a menu item 230 could be made to match or complement a background of a menu item 230, 235. Alternatively or additionally, the device 120 could be programmed to generate a contrast between certain elements, e.g., as could be useful for a background and/or text of menu items 235 to contrast with a color of the background 225.

### Exemplary Process Flows

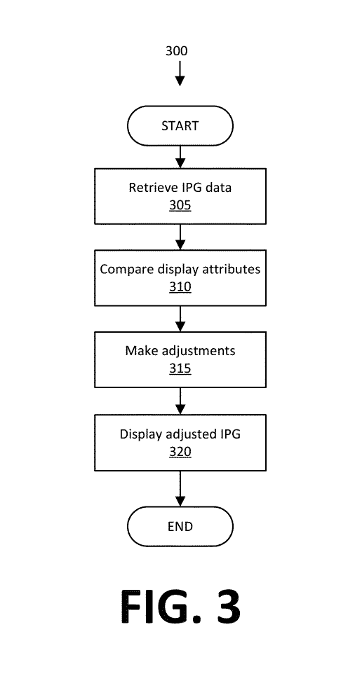

FIG. 3 is a diagram of an exemplary process for dynamically generating a graphical user interface such as an interactive program guide. The process 300 begins in a block 305, in which the media device 120 retrieves IPG data 115 from the media source 105. For example, a user could provide input to the media device 120 requesting to view the IPG 130. Accordingly, the media device 120 could be programmed to request IPG data 115, e.g., relating to an item of media content 110 such as a television program, movie, sporting event, etc., from the media source 105.

Next, in a block 310, the media device 120 compares content attributes 117 with IPG element attributes 118, e.g., as described above. For example, the media device 120 may compare colors, fonts, shapes, sounds, etc. specified by the attributes 117, 118, with one another. Further, although the content attributes 117 may be provided by the remote media source 105, they also could be identified by the media device 120.

Next, in a block 315, the media device 120 generates a graphical user interface, e.g., the IPG 130, based on the comparison performed in the block 310. Generation of the IPG 130, for example, may be performed according to rules specifying menu elements 230, 235 in the IPG 130 that should be either complementary or contrasting with elements content 210, e.g., as discussed above.

Next, in a block 320, the media device 120 provides the IPG 134 display in the display 125.

Following the block 320, the process 300 ends.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical, flash, or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A computing device, comprising a processor and a memory, the memory storing instructions executable by the processor, the instructions including instructions:
receive a stream of compressed digital data that includes an item of media content;
provide a graphical user interface to a display;
receive data specifying display elements for the graphical user interface, including at least a first display element that is selectable by a user, and a second display element that is not selectable by a user and provides with a description of an item of media content;
perform a comparison of one or more display attributes of the first element with one or more display attributes of the second element; and
cause the display, in providing the graphical user interface to the display, to adjust a display characteristic of at least one of the first and second display elements based at least on part on the comparison to provide one of a complementary and a contrasting display of the first and second display elements.

2. (canceled)

3. The device of claim 1, wherein the first display element is one of a link, a menu item, and a user instructions.

4. The device of claim 1, wherein the second display element is one of text, an image, audio, video, and a background associated with the item of media content.

5. The device of claim 1, wherein the display characteristic is one of a color, a font, and a brightness of a display element.

6. The device of claim 1, further programmed to identify the display characteristic to be adjusted.

7. The device of claim 1, further programmed to receive an identification of the display characteristic to be adjusted from a remote source.

8. The device of claim 1, further programmed to receive the item of media content, and to provide the media content to a display.

9. The device of claim 1, wherein the graphical user interface is an interactive program guide.

10. (canceled)

11. A method, comprising:
receiving a stream of compressed digital data that includes an item of media content;
providing a graphical user interface to a display;
receiving data specifying display elements for the graphical user interface, including at least a first display element that is selectable by a user, and a second display element that is not selectable by a user and provides with a description of an item of media content;
performing a comparison of one or more display attributes of the first element with one or more display attributes of the second element; and
causing the display, in providing the graphical user interface to the display, to adjust a display characteristic of at least one of the first and second display elements based at least on part on the comparison to provide one of a complementary and a contrasting display of the first and second display elements.

12. The method of claim 11, further comprising.

13. The method of claim 11, wherein the first display element is one of a link, a menu item, and a user instructions.

14. The method of claim 11, wherein the second display element is one of text, an image, audio, video, and a background associated with the item of media content.

15. The method of claim 11, wherein the display characteristic is one of a color, a font, and a brightness of a display element.

16. The method of claim 11, further comprising identifying the display characteristic to be adjusted.

17. The method of claim 11, further comprising receiving an identification of the display characteristic to be adjusted from a remote source.

18. The method of claim 11, further comprising receiving the item of media content, and to providing the media content to a display.

19. The method of claim 11, wherein the graphical user interface is an interactive program guide.

20. (canceled)
